(19) United States
(12) Patent Application Publication
(10) Pub. No.: US 2025/0340147 A1
(43) Pub. Date: Nov. 6, 2025

(54) TECHNIQUES FOR PREVENTING OVERVOLTAGE IN A HIGH VOLTAGE BATTERY DURING COLD AMBIENT AND HIGH SOC CONDITIONS

(71) Applicant: FCA US LLC, Auburn Hills, MI (US)

(72) Inventors: Rudolf Kharpari, Auburn Hills, MI (US); Venkatasubramanian Sankara Raman, Rochester Hills, MI (US); Moaed Abd, Kalamazoo, MI (US)

(21) Appl. No.: 18/652,885

(22) Filed: May 2, 2024

(51) Int. Cl. B60L 53/62; B60L 53/16; B60L 53/22

(52) U.S. Cl. CPC B60L 53/62; B60L 53/22; B60L 53/16; B60L 2240/545

(57) ABSTRACT

A charging control system for a high voltage battery system of an electrified vehicle includes an on-board charging module (OBCM) configured to control a charging current provided to the high voltage battery system and a supervisory controller configured to perform closed-loop control of a requested charging current provided to the OBCM based on feedback from the OBCM including a commanded charging current, wherein the closed-loop control is based on an accumulation of an error between the requested and commanded charging currents and, when the accumulated error exceeds a threshold, temporarily adjust the closed-loop control of the commanded charging current request to the OBCM to prevent an overvoltage malfunction of the high voltage battery system by (i) suspending the accumulation of the error, (ii) decrementing the accumulated error, and (iii) updating the requested charging current to compensate for a lesser load than a total load on the electrified vehicle.

### FIELD

The present application generally relates to electrified vehicles and, more particularly, to techniques for preventing overvoltage in a high voltage battery during cold ambient and high state of charge (SOC) conditions.

### BACKGROUND

Some electrified vehicles include a high voltage battery system that is configured for plug-in recharging via an external power source. During recharging, a supervisory controller sends a charging current request to an on-board charging module (OBCM), which in turn controls charging of the high voltage battery system. At certain operating conditions, the charging current is very low in order to protect the high voltage battery system from overcharging. In some cases and as shown in FIG. 1A, the OBCM does not communicate this limitation to the supervisory controller, which in turn accumulates error as if the OBCM is not meeting expectations. This causes the charging current request to windup, which in turn causes the OBCM to rapidly react and overshoot the target value thereby triggering an overvoltage malfunction. This is exacerbated by the slower operating speed of the supervisory controller compared to the OBCM. Accordingly, while such conventional high voltage battery charging techniques do work for their intended purpose, there exists an opportunity for improvement in the relevant art.

### SUMMARY

According to one example aspect of the invention, a charging control system for a high voltage battery system of an electrified vehicle is presented. In one exemplary implementation, the charging control system comprises an on-board charging module (OBCM) configured to control a charging current provided to the high voltage battery system and a supervisory controller configured to perform closed-loop control of a requested charging current provided to the OBCM based on feedback from the OBCM including a commanded charging current, wherein the closed-loop control is based on an accumulation of an error between the requested and commanded charging currents, and when the accumulated error exceeds a threshold, temporarily adjust the closed-loop control of the commanded charging current request to the OBCM to prevent an overvoltage malfunction of the high voltage battery system by (i) suspending the accumulation of the error, (ii) decrementing the accumulated error, and (iii) updating the requested charging current to compensate for a lesser load than a total load on the electrified vehicle.

In some implementations, the supervisory controller is configured to resume normal closed-loop control of the requested charging current in response to positive feedback from the OBCM. In some implementations, the accumulated error is decremented by a fixed value. In some implementations, the requested charging current is updated to compensate only for direct current (DC) loads on the electrified vehicle. In some implementations, the supervisory controller is further configured to determine the requested charging current as a function of (i) ambient temperature of the high voltage battery system and (ii) a state of charge (SOC) of the high voltage battery system. In some implementations, the commanded charging current by the OBCM is approximately zero at (i) ambient temperatures of approximately negative 28 degrees Celsius and at (ii) approximately a 93% SOC. In some implementations, an operating speed of the OBCM is faster than an operating speed of the supervisory controller. In some implementations, the operating speed of the OBCM is approximately one millisecond and wherein the operating speed of the supervisory controller is hundreds of milliseconds. In some implementations, the high voltage battery system receives the charging current from an external power source via plug-in electrified vehicle supply equipment (EVSE).

According to another example aspect of the invention, a charging control method for a high voltage battery system of an electrified vehicle is presented. In one exemplary implementation, the charging control method comprises controlling, by an OBCM of the electrified vehicle, a charging current provided to the high voltage battery system, performing, by a supervisory controller of the electrified vehicle, closed-loop control of a requested charging current provided to the OBCM based on feedback from the OBCM including a commanded charging current, wherein the closed-loop control is based on an accumulation of an error between the requested and commanded charging currents, and when the accumulated error exceeds a threshold, temporarily adjusting, by the supervisory controller, the closed-loop control of the commanded charging current request to the OBCM to prevent an overvoltage malfunction of the high voltage battery system by (i) suspending the accumulation of the error, (ii) decrementing the accumulated error, and (iii) updating the requested charging current to compensate for a lesser load than a total load on the electrified vehicle.

In some implementations, the charging control method further comprising resuming, by the supervisory controller, normal closed-loop control of the requested charging current in response to positive feedback from the OBCM. In some implementations, the accumulated error is decremented by a fixed value. In some implementations, the requested charging current is updated to compensate only for DC loads on the electrified vehicle. In some implementations, the charging control method further comprises determining, by the supervisory controller, the requested charging current as a function of (i) ambient temperature of the high voltage battery system and (ii) an SOC of the high voltage battery system. In some implementations, the commanded charging current by the OBCM is approximately zero at (i) ambient temperatures of approximately negative 28 degrees Celsius and at (ii) approximately a 93% SOC. In some implementations, an operating speed of the OBCM is faster than an operating speed of the supervisory controller. In some implementations, the operating speed of the OBCM is approximately one millisecond and wherein the operating speed of the supervisory controller is hundreds of milliseconds. In some implementations, the high voltage battery system receives the charging current from an external power source via plug-in EVSE.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A is a plot of an example high voltage battery system overvoltage malfunction resulting from the charging control techniques according to the prior art;

FIG. 1B is a plot of example high voltage battery system charge power limits based on state of charge versus temperature according to the principles of the present application;

FIG. 2 is a functional block diagram of an electrified vehicle having an example charging control system for a high voltage battery system according to the principles of the present application; and

FIG. 3 is a flow diagram of an example charging control method for a high voltage battery system of an electrified vehicle according to the principles of the present application.

### DESCRIPTION

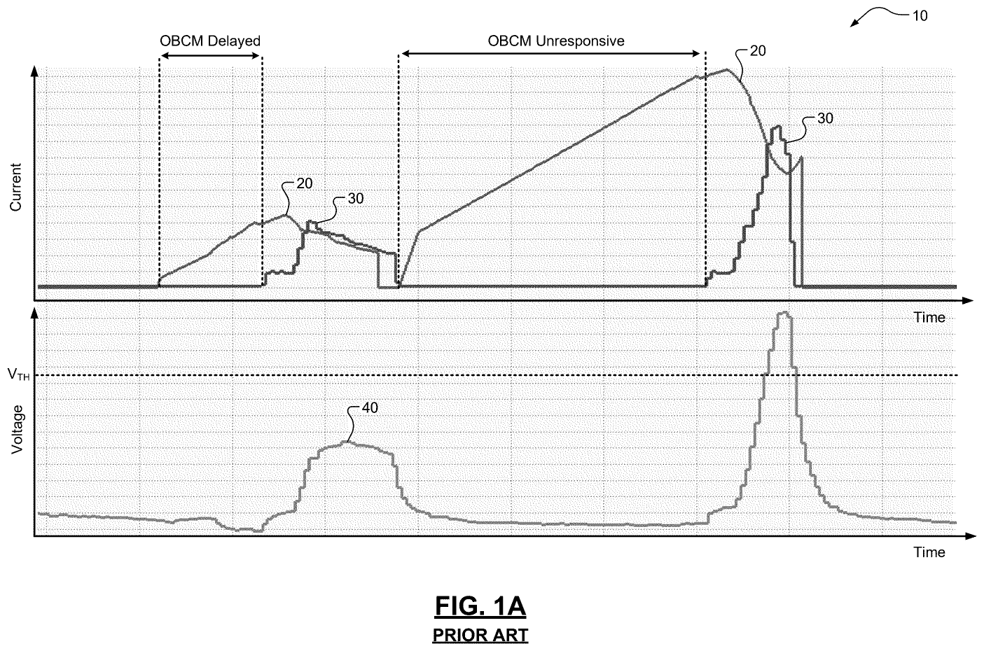

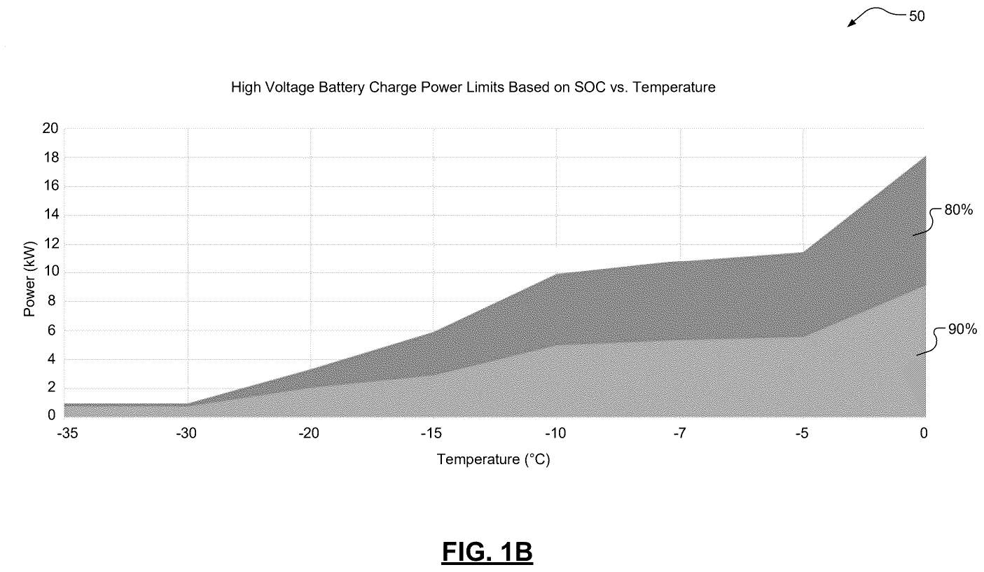

As previously discussed, during plug-in recharging of a high voltage battery system of an electrified vehicle, the charging current controlled by an on-board charging module (OBCM) could be very low (e.g., ˜0 A) at certain operating conditions in order to protect the high voltage battery system from overcharging. FIG. 1B illustrates a plot 50 of these operating conditions and, more specifically, specific low ambient temperatures (e.g., ˜−28° Celsius or lower) and high states of charge (SOCs) of the high voltage battery system (e.g., 80%, 90%, or higher) where this could occur. As previously discussed, in some cases and as also shown in the plot of FIG. 1A, the OBCM does not communicate this limitation to a supervisory controller of the electrified vehicle (e.g., due to hardware limits/protections), and as a result the supervisory controller calculates and accumulates an error as if the OBCM is not meeting expectations. This causes the charging current request 20 from the supervisory controller to windup, which in turn causes the OBCM to rapidly react (see actual charging current 30) and overshoot the target value thereby triggering an overvoltage malfunction (i.e., the voltage 40 exceeds a threshold VTH). This is exacerbated by the slower operating speed of the supervisory controller compared to the OBCM.

Accordingly, improved charging control systems and methods for a high voltage system of an electrified vehicle that prevent overvoltage malfunctions of the high voltage battery system are presented herein. First, the high voltage charging current request is determined by the supervisory controller as a function of SOC and ambient temperature. When the charging current request is not satisfied by the OBCM due to a slow response or no response, the supervisory controller temporarily modifies the closed-loop control to prevent an overvoltage malfunction of the high voltage battery system. This includes temporarily 1) suspending error accumulation, (2) decrementing the accumulated error (e.g., by a fixed value), and (3) updating the charging current request to compensate for a lesser load than a total load on the electrified vehicle (e.g., to only compensate for direct current (DC) loads). Eventually, this adjusted/modified closed-loop control could result in a deadlock situation with no charging current if the OBCM never recovers. When there is positive feedback from the OBCM, however, normal error accounting and accumulation for closed-loop charging control of the high voltage battery system is able to be resumed. Potential benefits of these techniques include protecting the high voltage battery system from potential damage and/or reduction of its useful life and thereby decreasing warranty/replacement costs.

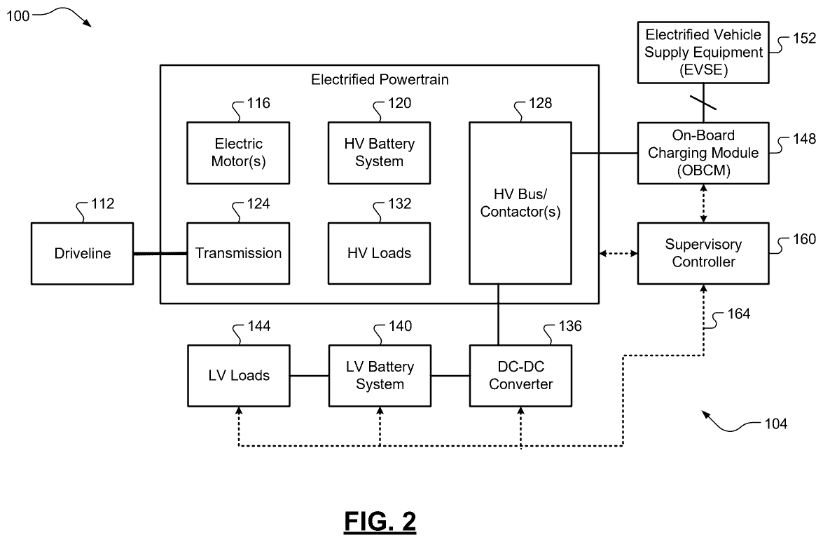

Referring now to FIG. 2, a functional block diagram of an electrified vehicle 100 (e.g., a plug-in hybrid electric vehicle, or PHEV) having an example charging control system 104 according to the principles of the present application is illustrated. The electrified vehicle 100 generally comprises an electrified powertrain 108 that is configured to generate and transfer drive torque to a driveline 112 vehicle propulsion. The electrified powertrain 108 includes one or more electric motors 116 powered by a high voltage (HV) battery system 120 and, in some implementations, a transmission 124 (e.g., a multi-speed automatic transmission) for transferring the drive torque from the electric motor(s) 116 to the driveline 112. A high voltage system of the electrified vehicle 100 also includes an HV bus/contactor(s) 128 (e.g., an HV bus with one or more HV contactors disposed between the HV bus and the HV battery system 120) and a set of HV loads 132 (an electric coolant heater, an electric air compressor, etc.). While not shown, it will be appreciated that the electrified powertrain 108 could also include an internal combustion engine that combusts a fuel/air mixture to generate mechanical energy that could be used for propulsion and/or for powering a motor/generator (not shown) for recharging a low voltage (LV) battery system 140 (e.g., a 12V battery).

The electrified vehicle 100 further includes an auxiliary power module (APM) or DC-DC converter 136 configured for recharging and supporting the LV battery system 140 and a corresponding set of DC loads 144 (e.g., 12V loads). The electrified vehicle 100 also includes an OBCM 148 configured to control charging of the high voltage battery system 120 (e.g., via the HV bus/contactor(s) 128) using electrified vehicle supply equipment (EVSE) 152 (e.g., an external charging unit, such as a roadside or residential charging station). For example, the OBCM 148 could connect to the EVSE 152 via charging connectors and cables (not shown). A supervisory controller or control system 160 controls operation of the electrified vehicle 100 and its components via a controller area network (CAN) 164. The control by the supervisory controller 160 primarily includes controlling the electrified powertrain 108 to generate a desired amount of drive torque to satisfy a driver torque request received via a driver interface (not shown, e.g., an accelerator pedal). The supervisory controller 160 is also configured to control recharging of the high voltage battery system 120 via the EVSE 152 and the OBCM 148, according to the techniques of the present application, which will now be described in greater detail.

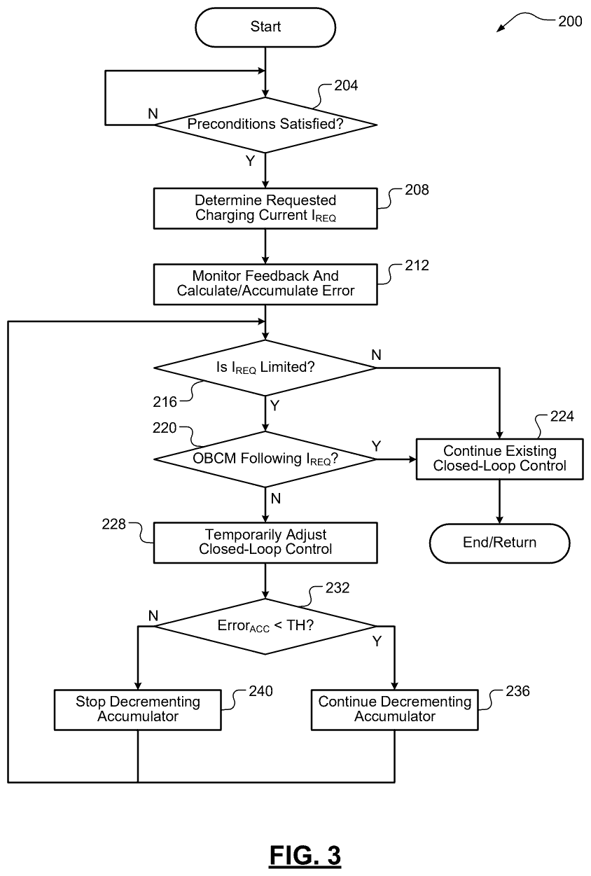

Referring now to FIG. 3 and with continued reference to FIG. 2, a flow diagram of an example charging control method 200 for a high voltage battery system of an electrified vehicle according to the principles of the present application is illustrated. While the components of the electrified vehicle 100 of FIG. 2 are specifically referenced for descriptive/illustrative purposes, it will be appreciated that the method 200 could be applicable to any suitably configured electrified vehicle. The method 200 begins at 204 where it is determined (e.g., by the supervisory controller 160) whether an optional set of one or more preconditions are satisfied. These preconditions could include, for example only, the electrified vehicle 100 (the OBCM 148) being properly connected (via plugs/cables) to the EVSE 152 and there being no faults or malfunctions present that would otherwise prevent or inhibit operation of the charging control techniques of the present application. When false, the method 200 ends or returns to 204. When true, the method 200 proceeds to 208. At 208, the supervisory controller 160 determines a requested charging current (I_{REQ}). This could be determined or calculated, for example, as a function of ambient temperature of the high voltage battery system 120 and SOC of the high voltage battery system 120, one or both of which could be measured by sensors (not shown) or modeled based on other parameters.

At 212, the supervisory controller 160 communicates the requested charging current I_{REQ} to the OBCM 148 and then monitors for feedback from the OBCM 148 and in the actual charging current (I_{ACT}) being provided by the EVSE 152 and the OBCM 148. A difference between the requested charging current and the actual charging current I_{ACT} (I_{REQ}−I_{ACT}) represents an error for closed-loop control. The supervisory controller 160 monitors and accumulates this error over a number of samples or time steps. At 216, the supervisory controller 160 determines whether the OBCM 148 is limiting the actual charging current I_{ACT} relative to the requested charging current I_{REQ}. When false, the method 200 proceeds to 220. When true, the method 200 proceeds to 224. At 220, the supervisory controller 160 determines whether the OBCM 148 is correctly tracking the requested charging current I_{REQ} in its control of the actual charging current I_{ACT}. When true, the method 200 proceeds to 224, where the supervisory controller 160 continues the existing closed-loop control and the method 200 then ends or returns to 204. When false, the method 200 proceeds to 228. At 228, the supervisory controller 160 temporarily adjusts the closed-loop control to prevent an overcharging or overvoltage malfunction of the high voltage battery system 120.

Specifically, the supervisory controller 160 adjusts or modifies the closed-loop control by temporarily (i) suspending the accumulation of the error, (ii) decrementing the accumulated error, and (iii) updating the requested charging current I_{REQ} to compensate for a lesser load than a total load on the electrified vehicle 100. The accumulated error (Error_{ACC}) could be decremented, for example, by a fixed amount or a fixed value. The requested charging current I_{REQ} could also be modified to compensate only for the LV loads 144 (e.g., and not the HV loads 132) of the electrified vehicle 100. At 232, the supervisory controller 160 determines whether the accumulated error Error_{ACC} is less than a threshold (TH). When true, the method 200 proceeds to 236 where the supervisory controller 160 continues decrementing the accumulated error Error_{ACC} and the method 200 then returns to 216. When false, the method 200 proceeds to 240 where the supervisory controller 160 stops decrementing the accumulated error Error_{ACC} and the method 200 then returns to 216. After returning to 216, if the requested charge current I_{REQ} is no longer limited or is now being followed by the OBCM 148, the method 200 then proceeds to 224 where the normal closed-loop control of the charging of the high voltage battery system 120 resumes.

It will be appreciated that the terms “controller” and “control system” as used herein refer to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A charging control system for a high voltage battery system of an electrified vehicle, the charging control system comprising:
an on-board charging module (OBCM) configured to control a charging current provided to the high voltage battery system; and
a supervisory controller configured to:
perform closed-loop control of a requested charging current provided to the OBCM based on feedback from the OBCM including a commanded charging current, wherein the closed-loop control is based on an accumulation of an error between the requested and commanded charging currents; and
when the accumulated error exceeds a threshold, temporarily adjust the closed-loop control of the commanded charging current request to the OBCM to prevent an overvoltage malfunction of the high voltage battery system by:
(i) suspending the accumulation of the error,
(ii) decrementing the accumulated error, and
(iii) updating the requested charging current to compensate for a lesser load than a total load on the electrified vehicle.

2. The charging control system of claim 1, wherein the supervisory controller is configured to resume normal closed-loop control of the requested charging current in response to positive feedback from the OBCM.

3. The charging control system of claim 1, wherein the accumulated error is decremented by a fixed value.

4. The charging control system of claim 1, wherein the requested charging current is updated to compensate only for direct current (DC) loads on the electrified vehicle.

5. The charging control system of claim 1, wherein the supervisory controller is further configured to determine the requested charging current as a function of (i) ambient temperature of the high voltage battery system and (ii) a state of charge (SOC) of the high voltage battery system.

6. The charging control system of claim 5, wherein the commanded charging current by the OBCM is approximately zero at (i) ambient temperatures of approximately negative 28 degrees Celsius and at (ii) approximately a 93% SOC.

7. The charging control system of claim 1, wherein an operating speed of the OBCM is faster than an operating speed of the supervisory controller.

8. The charging control system of claim 7, wherein the operating speed of the OBCM is approximately one millisecond and wherein the operating speed of the supervisory controller is hundreds of milliseconds.

9. The charging control system of claim 1, wherein the high voltage battery system receives the charging current from an external power source via plug-in electrified vehicle supply equipment (EVSE).

10. A charging control method for a high voltage battery system of an electrified vehicle, the charging control method comprising:
controlling, by an on-board charging module (OBCM) of the electrified vehicle, a charging current provided to the high voltage battery system;
performing, by a supervisory controller of the electrified vehicle, closed-loop control of a requested charging current provided to the OBCM based on feedback from the OBCM including a commanded charging current, wherein the closed-loop control is based on an accumulation of an error between the requested and commanded charging currents; and
when the accumulated error exceeds a threshold, temporarily adjusting, by the supervisory controller, the closed-loop control of the commanded charging current request to the OBCM to prevent an overvoltage malfunction of the high voltage battery system by:
(i) suspending the accumulation of the error,
(ii) decrementing the accumulated error, and
(iii) updating the requested charging current to compensate for a lesser load than a total load on the electrified vehicle.

11. The charging control method of claim 10, further comprising resuming, by the supervisory controller, normal closed-loop control of the requested charging current in response to positive feedback from the OBCM.

12. The charging control method of claim 10, wherein the accumulated error is decremented by a fixed value.

13. The charging control method of claim 10, wherein the requested charging current is updated to compensate only for direct current (DC) loads on the electrified vehicle.

14. The charging control method of claim 10, further comprising determining, by the supervisory controller, the requested charging current as a function of (i) ambient temperature of the high voltage battery system and (ii) a state of charge (SOC) of the high voltage battery system.

15. The charging control method of claim 14, wherein the commanded charging current by the OBCM is approximately zero at (i) ambient temperatures of approximately negative 28 degrees Celsius and at (ii) approximately a 93% SOC.

16. The charging control method of claim 10, wherein an operating speed of the OBCM is faster than an operating speed of the supervisory controller.

17. The charging control method of claim 16, wherein the operating speed of the OBCM is approximately one millisecond and wherein the operating speed of the supervisory controller is hundreds of milliseconds.

18. The charging control method of claim 10, wherein the high voltage battery system receives the charging current from an external power source via plug-in electrified vehicle supply equipment (EVSE).
